(19) United States
(12) Patent Application Publication
(10) Pub. No.: US 2003/0161780 A1
(43) Pub. Date: Aug. 28, 2003

(54) Recycle for supercritical carbon dioxide

(75) Inventors: Henry Edward Howard, Grand Island, NY (US); John Fredric Billingham, Getzville, NY (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Praxair Technology, Inc., Danbury, CT

(21) Appl. No.: 10/274,302

(22) Filed: Oct. 17, 2002

Related U.S. Application Data
(60) Provisional application No. 60/330,150, filed on Oct. 17, 2001.
(60) Provisional application No. 60/330,203, filed on Oct. 17, 2001.
(60) Provisional application No. 60/350,688, filed on Jan. 22, 2002.
(60) Provisional application No. 60/358,065, filed on Feb. 19, 2002.

(51) Int. Cl. C01B 31/20

(52) U.S. Cl. 423/437.1

(57) ABSTRACT

A method and a system for supplying a carbon dioxide fluid feed from a carbon dioxide purifying means to one or more applications. The feed is combined with contaminants at the applications to form an effluent, and at least one effluent is returned to the purifying means for recycling the carbon dioxide. Carbon dioxide from a carbon dioxide source is combined with the carbon dioxide of the system so that the purity of the carbon dioxide from the source is upgraded prior to the applications.

### RELATED APPLICATIONS

This application claims the benefit of U.S. Provisional Application No. 60/330,150, filed on Oct. 17, 2001, the entire teachings of which are incorporated herein by reference. This application also claims priority to U.S. Provisional Application Nos. 60/330,203, filed Oct. 17, 2001, 60/350,688, filed Jan. 22, 2002, and 60/358,065, filed Feb. 19, 2002; the entire teachings of all these applications are incorporated herein by reference.

### BACKGROUND OF THE INVENTION

The manufacture of integrated circuits generally involves a number of discrete steps that are performed on a wafer. Typical steps include depositing or growing a film, patterning the wafer using photolithography, and etching. These steps are performed multiple times to build the desired circuit. Additional process steps may include ion implantation, chemical or mechanical planarization, and diffusion. A wide variety of organic and inorganic chemicals are used to conduct or to remove waste from these processes. Aqueous-based cleaning systems have been devised to eliminate some of the organic solvent requirements, but they generate large quantities of waste that must be treated prior to discharge or reclamation. The need for large quantities of water is often a major factor in choosing a location for a semiconductor fabrication facility. In addition, the high surface tension of water reduces its effectiveness in applications requiring the cleaning of fine structures, and drying steps must be included in the process to remove all traces of moisture.

In recent years, supercritical carbon dioxide has been investigated as a potential replacement for some of the organic solvents and aqueous-based chemistries currently in use. Supercritical carbon dioxide systems have been known for decades in simple extraction processes, such as the decaffeination of coffee. The term supercritical fluid refers to a fluid that is above a critical temperature and pressure (e.g., at or above 31° C. and 1070 pounds per square inch absolute (psia) respectively, for carbon dioxide). Supercritical fluids have both gas- and liquid-like properties. The density of supercritical fluids can be varied as a function of temperature and pressure. Because solvating ability is a strong function of density this also means that the solvating properties can also be varied. Pure supercritical carbon dioxide has solvent capabilities similar to a non-polar organic solvent such as hexane. Modifying agents such as co-solvents, surfactants, and chelating agents can be added to the carbon dioxide to improve its cleaning ability.

Semiconductor-processes can generally produce a range of contaminants with vapor pressures either above or below that of carbon dioxide. The lighter, higher vapor pressure components may be some combination of fluorine, light fluorinated hydrocarbons and atmospheric gases such as nitrogen and oxygen. The carbon dioxide will also be contaminated with non-volatile resist residue compounds and co-solvents, which are difficult to transfer because they can exist as a solid/liquid mixture in combination with vapor phase carbon dioxide. Also, carbon dioxide purity requirements for many semiconductor manufacturing applications exceed those of currently available delivered bulk carbon dioxide. Furthermore, if supercritical carbon dioxide processes are to be widely used in the semiconductor industry, the quantities consumed will likely preclude the economic viability of total dependence on delivered carbon dioxide.

The prior art, however, does not teach a system or method by which these problems may be overcome. There is therefore a need for a method and apparatus for using carbon dioxide in a semiconductor manufacturing process that minimizes or eliminates these problems.

### SUMMARY OF THE INVENTION

The invention generally relates to a method and a system for purifying and recycling carbon dioxide.

The method of the invention includes the steps of directing a fluid feed, that includes a carbon dioxide component, from a first carbon dioxide purifying means to one or more applications, whereby one or more contaminants are combined with the fluid at the applications. An effluent is thereby formed at each application, wherein the effluent includes at least a portion of the carbon dioxide component and at least a portion of the contaminants. At least a portion of the effluent is directed to the first purifying means, where the carbon dioxide component of the effluent is purified, thereby producing the fluid feed. The first purifying means removes at least a portion of components that have vapor pressures different from the vapor pressure of carbon dioxide by using at least one member of the group consisting of means of catalytic oxidizing, distilling, and adsorbing, and directs the portion of components so removed to at least one waste stream. Also included is adding carbon dioxide from a carbon dioxide source by a step selected from the following group. One step combines the carbon dioxide from the source with the effluent, whereby carbon dioxide from the source is purified by the first purifying means. Another step adds carbon dioxide from the source to the first purifying means while purifying the carbon dioxide component of the effluent in the first purifying means, whereby carbon dioxide from the source is purified by the first purifying means. Still another step includes purifying carbon dioxide from the source in a second carbon dioxide purifying means, thereby creating a pre-purified feed,; and adding the pre-purified feed to at least one member of the group consisting of the fluid feed, at least one application, the effluent, and the first purifying means. The second purifying means includes at least one member of the group consisting of distillation, adsorption, and catalytic oxidation

The system of the invention includes a first carbon dioxide purifying means, which purifies a carbon dioxide component of an effluent, whereby at least a portion of components that have vapor pressures different from the vapor pressure of carbon dioxide are removed. At least one waste stream is formed and a fluid feed that includes the carbon dioxide as a component of the fluid feed is formed. The first purifying means includes at least one member of the group consisting of a catalytic oxidizer, a distillation column, and an adsorption bed. A supply conduit directs the fluid feed from the first purifying means to one or more applications, whereby one or more contaminants are combined with the fluid, thereby forming an effluent at each application. Each effluent includes at least a portion of the carbon dioxide component and at least a portion of the contaminants. A return conduit directs the effluent from at least one application to the first purifying means. A carbon dioxide source and a means to purify and add additional carbon dioxide from the source is included, wherein the means are selected from the group consisting of the following means. One means direct carbon dioxide from the source to at least one member of the group consisting of the first purifying means, an effluent, and the return conduit, whereby carbon dioxide from the source is purified by the first purifying means before being directed to the applications. Another means purifies and adds carbon dioxide from the source by including means to direct carbon dioxide from the source to a second carbon dioxide purifying means. The second carbon dioxide purifying means, which produced a purified feed, includes at least one member of the group consisting of a distillation column, an adsorption bed, and a catalytic oxidizer; and means to add a purified feed to at least one member of the group consisting of the supply conduit, at least one application, the return conduit, and the first purifying means.

The advantages of the invention disclosed herein are significant. Practicing the invention can significantly reduce the cost and complexity of supplying high-purity carbon dioxide for a semiconductor manufacturing facility. By recycling carbon dioxide, the amount, and therefore the cost of delivered carbon dioxide is reduced. By purifying delivered carbon dioxide prior to the applications, the cost is reduced because the delivered carbon dioxide can be purchased at a lower purity level. By providing a centralized purification facility, economies of scale are realized over individual purification and delivery units. By removing contaminants with vapor pressures that are either above or below that of carbon dioxide, a wide range of contaminants produced in a semiconductor manufacturing process can be removed to produce a recycled carbon dioxide stream that is sufficiently pure for reuse in such a process. The combination of these advantages are expected to make supercritical carbon dioxide a viable replacement for existing organic solvent and aqueous chemistry processes, resulting in lower production costs for semiconductors.

### BRIEF DESCRIPTION OF THE DRAWINGS

FIG. 1 depicts an apparatus of one embodiment of the present invention.

FIG. 2 depicts an apparatus of an alternative embodiment of the present invention.

FIG. 3 depicts an apparatus of an alternative embodiment of the present invention.

FIG. 4 depicts an apparatus of an alternative embodiment of the present invention.

FIG. 5 depicts an apparatus of an alternative embodiment of the present invention using carbon dioxide recycle compression.

FIG. 6 shows a detailed portion of an embodiment of the present invention.

### DETAILED DESCRIPTION OF THE INVENTION

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

The present invention generally is directed to a carbon dioxide purification and recycle process and system that can eliminate both heavy and light contaminants from a carbon dioxide stream, and minimize make-up carbon dioxide requirements.

“High purity” carbon dioxide is defined herein as a carbon dioxide stream where each contaminant is below about 100 parts per million (ppm). Alternatively, each contaminant is below about 10 ppm. Preferably, each contaminant is below about 1 ppm. This high purity stream can be accomplished through: 1) separating most of the co-solvents and heavy contaminants from the carbon dioxide stream prior to passing the stream to a distillation, so that the resulting vapor stream can be free of solid and liquid contaminants that would adversely affect fluid transfer to the distillation, and 2) distilling the resulting pre-purified, carbon dioxide enriched vapor to form high purity carbon dioxide.

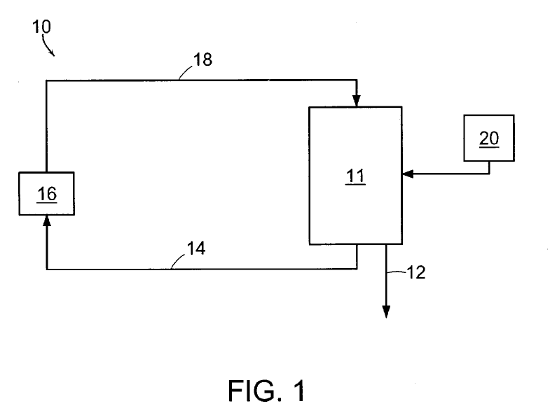

FIG. 1 is a schematic of apparatus 10, one embodiment of the present invention. The apparatus includes a first carbon dioxide purifying means 11, which purifies a carbon dioxide component of an effluent by removing components that have vapor pressures different from carbon dioxide. Purifying means 11 includes at least a distillation column, a catalytic oxidizer, a phase separator, or an adsorption bed. A fluid feed that includes a carbon dioxide component can be formed, as well as at least one waste stream 12. The fluid feed is directed from the first purifying means via supply conduit 14 to one or more applications 16. Contaminants can be combined with the fluid at the applications, thereby forming an effluent at each application. Each effluent is composed of carbon dioxide and one or more contaminants. Return conduit 18 directs at least a portion of the effluent back to first purifying means 11 to recycle the carbon dioxide.

Also included in the embodiment in FIG. 1 is an external carbon dioxide source 20. Examples of carbon dioxide sources are a reservoir, a carbon dioxide generating plant, a railroad tank car, and a truck trailer. The carbon dioxide from the source can be added to the system to make up for losses in normal processing or to increase the amount of carbon dioxide in the system as additional applications are brought on line. The carbon dioxide that is added is purified by one of several means before it reaches the application. Source 20 can include a second carbon dioxide purifying means, which contains at least a distillation column, a catalytic oxidizer, a phase separator, or an adsorption bed. When the carbon dioxide from the source is sufficiently pre-purified in this manner, it can be added to any point in the system. Preferably, however, carbon dioxide from the source is added to a point in the system, such as return conduit 18 or first purifying means 11, so the added carbon dioxide from the source is purified by first purifying means 11, thus obviating the need for an additional, external purifying unit.

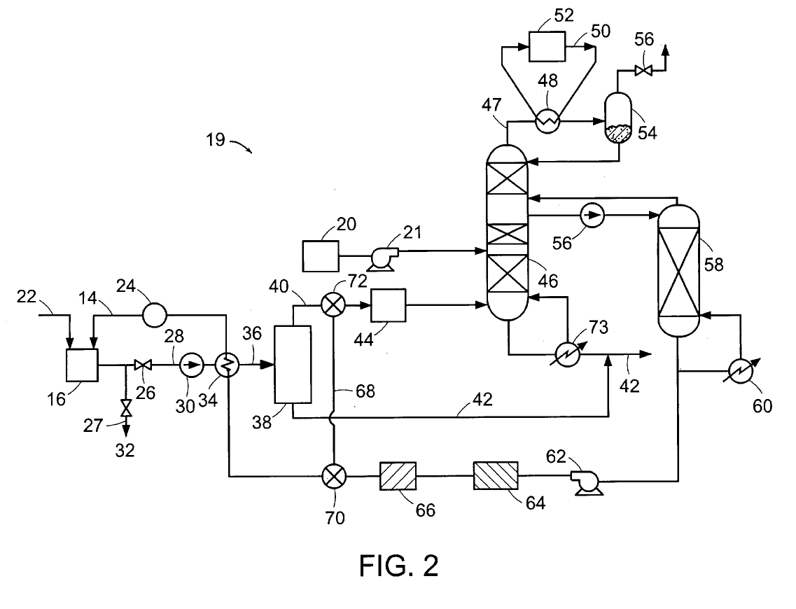

FIG. 2 describes apparatus 19, an embodiment of the invention where a semiconductor application 16 can be fed with a carbon dioxide fluid feed via supply conduit 14. Application 16 can be, for example, a photoresist removal process, a chemical fluid deposition process, a photoresist deposition process, or a photoresist development process. Also added is a second component 22, which can include one or more co-solvents, surfactants, chelators, or other additives to enhance the cleaning process. The second component can be added to the application as shown or to the fluid feed in conduit 14 prior to the application.

Physical properties of the fluid feed including temperature and pressure can be changed using a heat exchanger and a pressure controller in customization unit 24. As used herein, a heat exchanger is any device that can raise or lower the temperature of a feed, such as an electric heater, a refrigeration unit, a heat pump, a water bath, and other devices know to the art. As used herein, a pressure controller can be any device that changes the pressure of a feed, including a pump, a compressor, a valve, and other devices known to the art. The customization unit can operate on the fluid feed in conduit 14 as shown or can be incorporated into the application itself. If more than one application exists, each application can have its own customization unit. In a preferred embodiment, the customization unit forms the carbon dioxide component of the fluid feed into a supercritical fluid.

An effluent containing carbon dioxide, the second component, and contaminants is discharged from application 16. The portion of the effluent that is at a pressure greater than the recycle system pressure can be passed to the recycle system as stream 28 after passing through valve 26. Pressure control device 30 can be used to further reduce or increase pressure. Pressure control device 30 can be, for example, a valve, pump or compressor, depending upon the state of the feed stream at the discharge of application 16. Typically, the pressure downstream of 30 is in a range of between about 200 to about 800 psia. That portion of the effluent that can be at a pressure below the recycle system pressure can be, for example, directed to a waste stream 27, which can then be directed to an abatement system such as facility exhaust system 32 of the semiconductor manufacturing plant.

In one embodiment, effluent 28 can be a multiphase mixture. Partial vaporization, such as by heating or cooling stream 28 against another process stream in heat exchanger 34, can be performed.

Stream 36 passes to third purifying means 38, which by reducing the pressure separates effluent 36 into at least two phases. Third purifying means 38 can be a phase separator such as a simple disengagement drum, a multi-stage contactor, or other devices known in the art. Alternatively, third purifying means 38 can be a distillation column, a catalytic oxidizer, or an adsorption bed. Typically, customization unit 24 and third purifying means 38 are located near application 16. Depending on the contaminants and second component composition, there may be a solid phase. Usually there will be a liquid phase enriched in, for, example, contaminants from the application and the second components. Depending on the contaminants and the second components, there can be more than one liquid phase. All phases can contain carbon dioxide, but generally the phase most enriched in carbon dioxide will be gas stream 40, which is then directed to the first purifying means. Phases enriched in components other than carbon dioxide can be directed to at least one waste stream 42.

In another embodiment, further purifying can be accomplished using chemical reactor 44, which can include means for catalytic oxidation, water scrubbing, acid scrubbing, base scrubbing, adsorption, and drying. Reactor 44 can serve to reduce contaminants such as H₂O, close-boiling hydrocarbons, oxygenated hydrocarbons, halogens or halogenated hydrocarbons issuing from the application. In one embodiment, reactor 44 includes a water or caustic wash column for the removal of chlorides or sulfur species followed by catalytic oxidation and adsorption. A preferred embodiment relies upon the distillation sequence and the criteria for co-solvent selection, so that reactor 44 may be eliminated.

After pretreatment in reactor 44, any remaining components that have vapor pressures lower than carbon dioxide are removed in enriching distillation column 46. Carbon dioxide from source 20 can be added to column 46, for instance, to upgrade bulk liquid carbon dioxide from carbon dioxide source 20. Optional pump 21 can be used to pump bulk liquid carbon dioxide if carbon dioxide source 20 is at a lower pressure than enriching distillation column 46. Source 20 can include an optional heater so that the added carbon dioxide can be added as a vapor or gas. Column 46 can contain suitable packing or trays in order to effect intimate contact of liquid and vapor. Overhead condenser 48 generates refluxing liquid. Condenser 48 is driven by refrigerant stream 50, which is supplied by refrigeration system 52.

The overhead gas from column 46 can be essentially free of high boiling contaminants. The partially condensed overhead can be phase separated in vessel 54, and a portion of the liquid condensate can be returned to column 46 as reflux. The overhead vapor can be discharged to atmosphere through valve 56. A waste stream 42 containing concentrated contaminants and co-solvent can be extracted from the bottom of column 46 and separator 38 and directed to other facility waste treatment operations.

Treatment of waste stream 42 can include a wide range of steps including co-solvent recovery, incineration or further distillation, depending on the facility. However, one possible option for increasing carbon dioxide recovery could involve a combination of successive re-heats, depressurization and phase separation. The gases evolved from such separations may be sufficiently enriched in carbon dioxide to warrant recompression back into the carbon dioxide distillation train.

A carbon dioxide liquid stream extracted from column 46 can be directed to column 58 through control device 56. Device 56 may be either a valve or mechanical pump. Column 58 rejects light gas contaminants (gases with vapor pressures higher than carbon dioxide), such as methane, nitrogen, fluorine, and oxygen. Column 58 can be a vessel filled with suitable packing or trays to facilitate liquid and vapor contact. Column reboil can be provided by heat exchanger 60.

The carbon dioxide fluid feed can be taken from column 58 and compressed to an elevated pressure in pump 62, and then directed to optional purifying component 64. Component 64 can remove heavy contaminants introduced into the system due to leaching of components from pipes, gasket material and in rotating/reciprocating machinery, and can be for example, an adsorption bed, such as an activated carbon bed. In other embodiments, component 64 can be located elsewhere in the system.

The fluid feed is then directed to component 66, which can be a filter package to remove particles down to a level suitable for semiconductor processing.

The high-pressure carbon dioxide temperature may be adjusted by passage through heat exchangers 24 and 34 to adjust the degree of sub-cooling.

In another embodiment, a bypass conduit 68 is used, including valves 70 and 72. This allows the first purifying means to be isolated from the applications and the third purifying means, so the first means can be operated as a continuous process, and the applications can be operated in batch mode.

The operating pressure of the purifying train is preferably in the range of about 90-900 psia and more preferably, in the range of about 100-400 psia. The pressure between pump 62 and application 16 in conduit 14 is preferably in the range of between about 750 and about 5000 psia, and more preferably in the range of between about 900 and about 3000 psia.

Numerous integration schemes are possible with the above arrangement. For example, the heat exchanger in 24, and heat exchangers 60 and 73 can be integrated with refrigeration system 52. As an example, reboil heat exchanger 60 may provide sub-cooling duty to a liquid refrigerant stream in system 52. The heat exchanger in customization unit 24 may reject its heat load into the refrigeration system or by indirect heat exchange to ambient temperature air or water (or chilled water). Additionally, heat exchanger 60 may serve to reboil column 58 as well as cool the feed gas.

In order to produce very high purity carbon dioxide from column 58, the second component can be selected to possess a number of physical attributes, such as solubility in carbon dioxide, and a normal boiling point greater than about −20° F., to assist rejection of the solvent via separator 38 and column 46. By using co-solvents and additives with normal boiling points in excess of about −20° F., a separation that utilizes phase separation and distillation can allow high purity carbon dioxide to be produced without additional unit operations. Even if such operations are required to remove contaminants introduced by the tool, the loading on these units can be considerably reduced.

Also, the co-solvent can be selected so that any decomposition species produced during use in an application do not have vapor pressures near carbon dioxide, or alternatively, do not have normal boiling point in the range of about −20° F. to −155° F. Avoiding co-solvents with decomposition products in this range can lead to more effective rejection of lighter contaminants via column 58. Preferred co-solvents for moderate temperature in current known semiconductor processes can include dimethyl sulfoxide (DMSO), dimethyl formamide (DMF), N-methyl pyrrolidone (NMP), tetrahydrofuran (THF), and propylene carbonate, among many others.

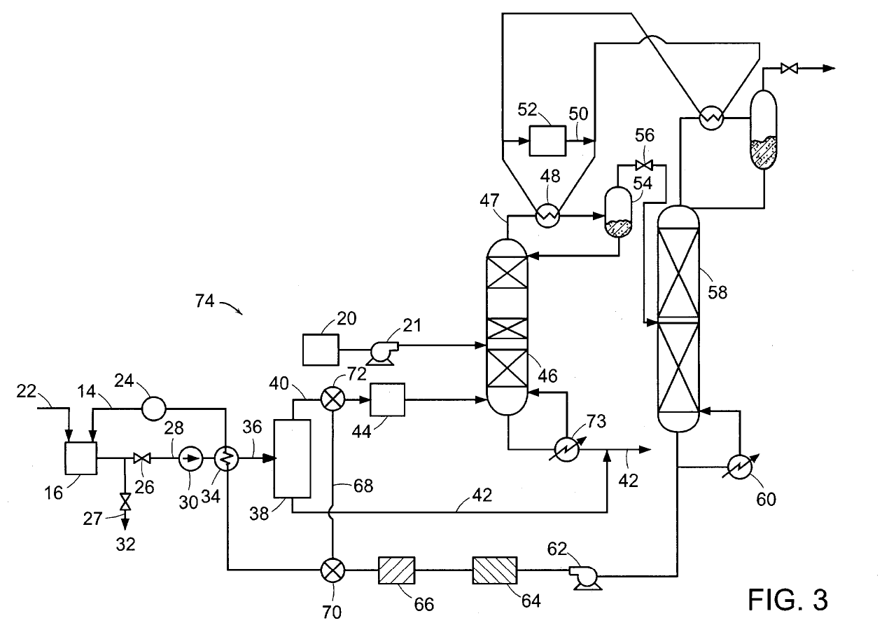

FIG. 3 illustrates an alternative column configuration to that illustrated in FIG. 2. As in FIG. 2, the vapor leaving reactor 44 can be fed to an enriching column 46. Waste stream 42, containing co-solvent and contaminants can be removed from the bottom of the column. An overhead condenser 48 generates refluxing liquid. The vapor leaving this vessel can be directed to distillation column 58. Column 58 rejects high vapor pressure contaminants and has a condenser 57 and reboiler/heat exchanger 60 associated with it. Light contaminants are vented from the condenser 57, while contaminant-free carbon dioxide can be withdrawn from reboiler 60.

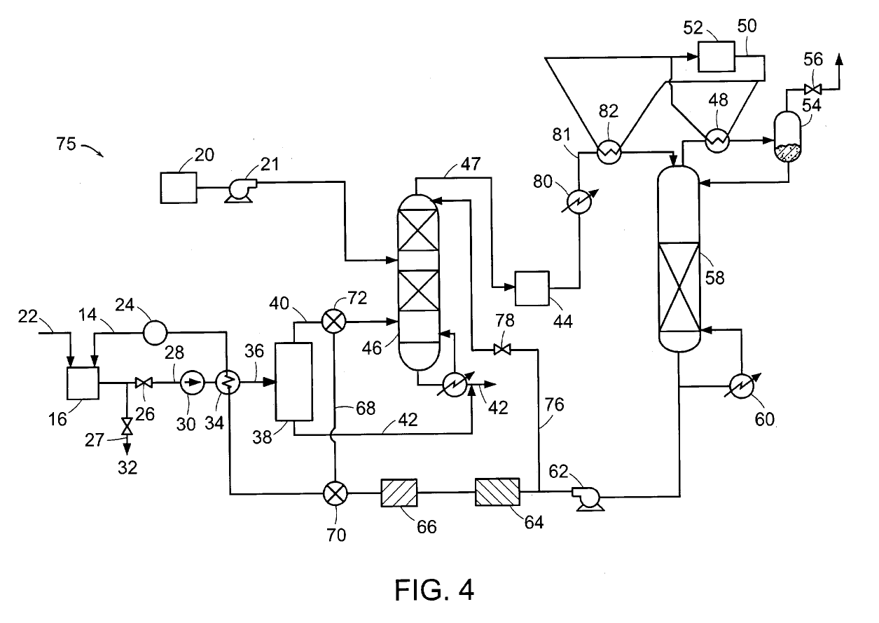

FIG. 4 shows apparatus 75 as an alternate embodiment. In apparatus 75, liquid carbon dioxide can be employed as an absorption fluid for rejection of contaminants with vapor pressures lower than that of carbon dioxide. An appropriate fluid could be very high purity liquid carbon dioxide that has been purified of at least high vapor pressure contaminants, or alternatively an ambient/super ambient separation followed by distillation of high vapor pressure contaminants. The absorptive capacity of a high purity carbon dioxide stream can be considerably higher than that obtained from direct condensation of overhead vapor, which can then result in overhead carbon dioxide vapor of high purity.

After cooling in heat exchanger 34, effluent stream can be introduced directly into column 46, which rejects low vapor pressure contaminants. A portion of the high purity carbon dioxide taken via side stream 76 can be directed through control valve 78 into the top of column 46. In addition, make-up carbon dioxide from carbon dioxide source 20 can be also introduced at an upper location of column 46. Alternatively, or in addition, carbon dioxide can be introduced at other points as described above. These streams serve to both cool the feed stream and to absorb heavy contaminants. Column 46 overhead can be then directed to reactor 44, which can be, for example, an ambient or superambient purifier such as a catalytic reactor, where residual contaminants having normal boiling points greater than −155° F. are removed. Purified feed stream exiting reactor 44 can be further cooled to near saturation in heat exchanger 80. The gas can be then substantially condensed in heat exchanger 82 and introduced into column 58. Condenser 48 can operate in tandem with heat exchanger 82. Alternatively, both heat exchangers can be consolidated into a single unit.

Reactor 44 can be partitioned between columns 46 and 58 to ensure the removal of any contaminants introduced in the application (by co-solvent decomposition or from the wafer itself, for example) that fall outside the preferred co-solvent vapor pressure range. Application 16 may reject a contaminated carbon dioxide stream with percent level (or greater) contamination. Operation of column 46 facilitates the reduction of contaminants typically down to the 1000 ppm level or less. By inclusion of separation reactor 44 between columns 46 and 58, the demand on reactor 44can be much reduced over that which would be required if all of the co-solvent added to the application had to be removed in it, leading to substantial cost savings. The inclusion of reactor 44 alleviates the criteria on the absorbed contaminants, and as discussed above, should be configured to address application specific contaminants.

FIGS. 2 and 3 depict the primary condensation of carbon dioxide occurring in a refrigerated heat exchanger 48. It can be possible for each column to operate with its own condenser and phase separator, which provides an advantage in controllability. Each column condenser shown can be located at ground level to facilitate servicing. In those instances, a liquid condensate pump may be included to transfer the liquid back to the top of the column. Alternatively, a reflux type condenser could take the place of both heat exchanger 48 and phase separator 54. It is not necessary to extract an interstage liquid draw as a primary feed to column 58; any location above the point where the heavy contaminants have been removed can be acceptable. These locations include taking liquid directly from the condenser or a portion of the condensate directly from vessel 54. Either column 46 or 58 can be reboiled by cooling the feed gas stream. Alternatively, heat exchanger 60 can be operated using a de-superheating or condensing refrigerant stream extracted from refrigeration system 52.

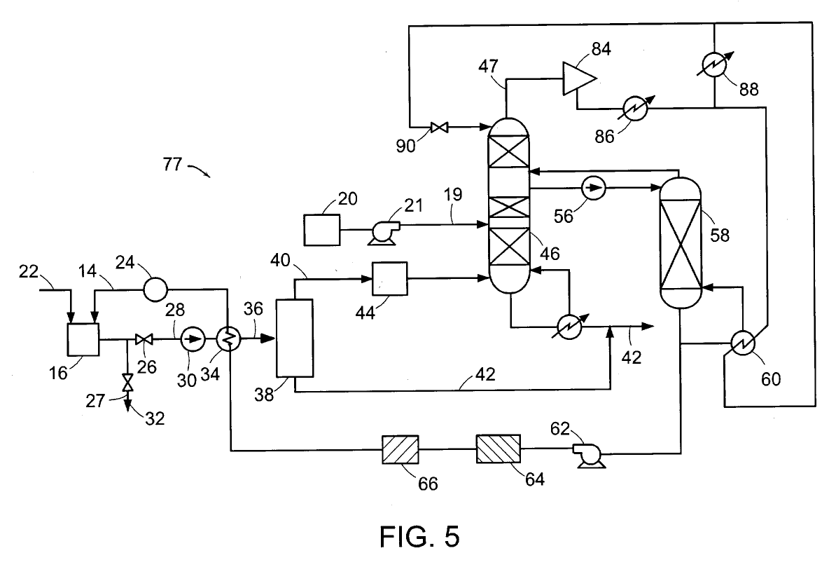

FIG. 5 illustrates apparatus 77, an embodiment of the invention that employs a carbon dioxide recycle compression circuit. In this embodiment, a carbon dioxide recycle loop provides plant refrigeration and column reboil. Overhead gas in column 46 can be compressed to a pressure typically in excess of 500 psia in compressor 84. Compressor 84 can be preferably of a reciprocating type and can incorporate oil removal if necessary (not shown). Compressor discharge can be cooled in heat exchanger 86 (cooling water or forced air). A portion of the high-pressure gas can be then condensed in heat exchanger 60 for purposes of providing reboil vapor to stripping column 58. The remaining portion of the compressed carbon dioxide gas may be condensed against chilled water or suitable refrigerant (not shown) in heat exchanger 88. Each carbon dioxide condensate stream can be then redirected to the top of column 46 through pressure reducing valve 90. The condensate serves to reflux column 46. Pure liquid leaves column 58 and can be pumped to supply pressure in pump 62. In this embodiment, the carbon dioxide itself can be used as the refrigeration working fluid rather than using a separate refrigerant such as ammonia.

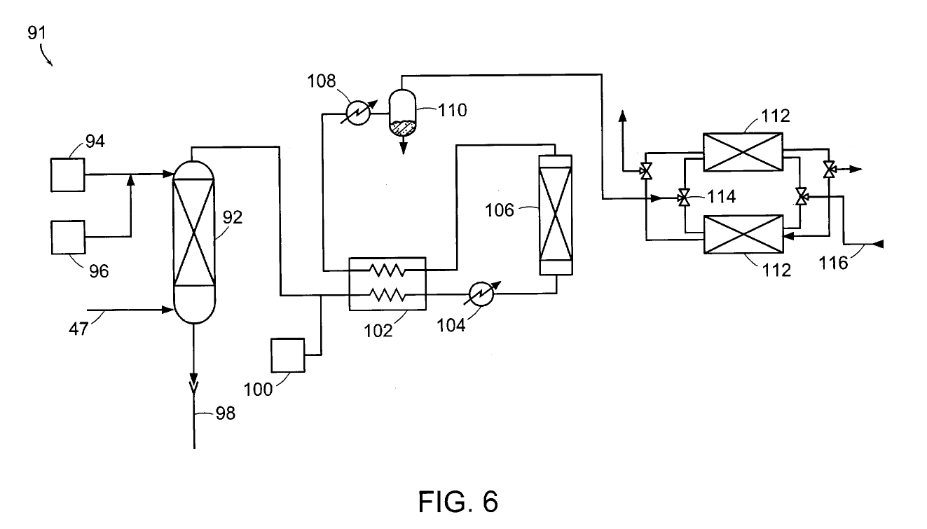

FIG. 6 describes apparatus 91, the details of one implementation of reactor 44. In this arrangement, effluent 47, which has been substantially freed of the co-solvent through distillation or phase separation (such as using separator 38 and column 46 in FIG. 2, for example) can be directed to absorption column 92. Within column 92, the gas can be contacted with water from source 94 and a basic additive (such as caustic soda) obtained from source 96. A portion of high vapor pressure contaminants (those exhibiting normal boiling points greater than −155° F.) are rejected in a waste stream 98 that can be directed to a suitable sewer or waste processing facility. Absorber column 92 overhead can be then mixed with an oxygen source (air or oxygen-enriched air, for example) obtained from system 100. System 100 can include a liquid oxygen tank, pump and vaporizer, or alternatively, an air compressor. The combined feed gas can be then warmed in gas/gas heat exchanger 102 to an elevated temperature (in general greater than about 400° F.). The gas may be further heated in heat exchanger 104, which may be electrically fired. The feed gas can be then freed of oxygenated hydrocarbons and small hydrocarbons by catalytic oxidation unit 106. Reactor 106 may consist of a vessel packed with supported noble-metal catalyst. After oxidation, the gas can be then sequentially cooled in heat exchangers 102 and 108. Heat exchanger 108 may utilize an ambient utility such as air or cooling water to absorb heat from the de-superheating carbon dioxide stream. The gas stream can be then freed of condensed water in phase separator 110. The carbon dioxide gas can be further dried in alumina beds 112. Valve system 114 can be configured to alternate the periodic switching of gas flow paths to regenerate the adsorption beds. Regeneration stream 116 may be any combination of heated air or dry storage gas.

### EXAMPLE

Table 1 gives values for the flow conditions and compositions of material streams corresponding to the process represented by FIG. 4. In this example, the feed stream has undergone phase separation in vessel 38 at reduced temperature following expansion, and has warmed to ambient temperature prior to entry into the first distillation column 46. The contaminants considered include oxygen, nitrogen, methane (introduced with the added liquid), water, hexane, propylene carbonate, acetone and ethyl acetate. With these impurities, reactor 44 and heat exchanger 80, between columns 46 and 58, are not required. In addition, condensers 48 and 82 will optimally be performed in the same unit.

The energy streams are listed in Table 2. The refrigeration power can be estimated based on the use of an ammonia refrigeration circuit. This circuit can be assumed to provide the energy to reboilers 41 and 44 and also assumes that chilled water is available at 4° C. to condense the high-pressure ammonia vapor in the refrigeration loop.

TABLE 1
Material streams associated with cycle represented by FIG. 4

| Stream | 28 | 36 | 42 | 19 | 81 | 76 | 14 |
|---|---|---|---|---|---|---|---|
| Temperature, ° C. | 25 | 0.3 | 0.1 | −13.00 | −13.9 | −5.3 | 8.5 |
| Pressure, psia | 356 | 355 | 355 | 355 | 350 | 2000 | 2000 |
| Flow, lbmol/hr | 9.51 | 9.51 | 0.05 | 0.84 | 10.90 | 0.60 | 9.97 |
| Composition: | | | | | | | |
| CO₂, % | 98.727 | 98.727 | 60.659 | 99.997 | 99.073 | 100.00 | 100.00 |
| Nitrogen, ppm | 8506 | 8506 | 376 | 0 | 7420 | 0.95 | 0.95 |
| Oxygen, ppm | 2120 | 2120 | 181 | 5 | 1849 | 1.00 | 1.00 |
| Methane, ppm | 0 | 0 | 0 | 20 | 2 | 0.01 | 0.01 |
| Water, ppm | 4.5 | 4.5 | 855 | 1.0 | 0.0 | 0.01 | 0.01 |
| Hexane, ppm | 1342 | 1342 | 250329 | 0 | 0 | 0.20 | 0.20 |
| Propylene | 1.5 | 1.5 | 287 | 0.0 | 0.0 | 0.00 | 0.00 |
| Carbonate, ppm | | | | | | | |
| Ethyl Acetate, ppm | 14 | 14 | 2688 | 0 | 0 | 0.00 | 0.00 |
| Acetone, ppm | 744 | 744 | 138692 | 0 | 0 | 0.00 | 0.00 |

TABLE 2
Energy streams associated with cycle represented by FIG. 3

| Number | Description | Duty, BTU/hr |
|---|---|---|
| 62 | Energy to Pump | 3030 |
| 14 | Heavy reboiler | 3517 |
| 60 | Lights reboiler | 7292 |
| 48 + 82 | Condenser duty | −61266 |
| 52 | Power to refrigeration system | 25171 |

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for supplying carbon dioxide to one or more applications, comprising the steps of
a. directing a fluid feed, that includes a carbon dioxide component, from a first carbon dioxide purifying means to one or more applications, whereby one or more contaminants are combined with the fluid at said applications, thereby forming an effluent at each said application, wherein each said effluent includes at least a portion of the carbon dioxide component and at least a portion of said contaminants;
b. directing at least a portion of said effluent to said first purifying means;
c. purifying the carbon dioxide component of said effluent at the first purifying means, thereby producing said fluid feed by
i) removing at least a portion of components that have vapor pressures different from the vapor pressure of carbon dioxide by using at least one member of the group consisting of means of catalytic oxidizing, distilling, and adsorbing; and
ii) directing the portion of components so removed to at least one waste stream; and
d. adding carbon dioxide from a carbon dioxide source by a method selected from the group consisting of
i) combining the carbon dioxide from the source with the effluent, whereby carbon dioxide from the source is purified by said first purifying means;
ii) adding carbon dioxide from the source to said first purifying means while purifying said carbon dioxide component of said effluent in said first purifying means, whereby carbon dioxide from the source is purified by said first purifying means; and
iii) pre-purifying and adding carbon dioxide including the steps of
(1) purifying carbon dioxide from the source in a second carbon dioxide purifying means, thereby creating a pre-purified feed, wherein said second purifying means includes at least one member of the group consisting of distillation, adsorption, and catalytic oxidation; and
(2) adding said pre-purified feed to at least one member of the group consisting of the fluid feed, at least one said application, the effluent, and said first purifying means.

2. The method of claim 1, further including the step of adding a second component to at least one member of the group consisting of the fluid feed and at least one said application, wherein said second component is selected from the group consisting of co-solvents, surfactants, and chelators.

3. The method of claim 2, further including the step of changing at least one physical property of the fluid feed prior to at least one said application, said property selected from the group consisting of temperature and pressure.

4. The method of claim 3, whereby at least a portion of the carbon dioxide component of the fluid feed is formed into a supercritical fluid.

5. The method of claim 3 wherein one or more third carbon dioxide purifying means partially purifies at least a portion of the carbon dioxide component of said effluent by
a. reducing the pressure of the effluent by an amount sufficient to separate the effluent into a plurality of phases, including at least one carbon dioxide enriched phase and at least one phase enriched in components other than carbon dioxide;
b. directing at least one carbon dioxide enriched phase to said first purifying means, whereby the carbon dioxide component of said carbon dioxide enriched phase is purified; and
c. directing at least one phase enriched in components other than carbon dioxide to at least one waste stream.

6. The method of claim 5, wherein said applications are selected from the group consisting of chemical fluid deposition, photoresist deposition, photoresist removal, and photoresist development.

7. The method of claim 6, wherein said first purifying means includes one or more distillation steps

8. The method of claim 7, wherein said first purifying means further comprises a step selected from the group consisting of adsorbing contaminants that have a vapor pressure lower than carbon dioxide and filtering solid contaminants.

9. The method of claim 8, wherein said first purifying means includes chemically reacting a component of the effluent other than carbon dioxide by at least one member of the group consisting of oxidizing, reducing, acid scrubbing, and base scrubbing.

10. The method of claim 9, further comprising a means to direct a portion of said fluid feed back to said first purifying means, thereby bypassing said applications and said third purifying means, whereby the first purifying means is operated as a continuous process.

11. The method of claim 10 wherein said second component includes at least one component that has a normal boiling point greater than about −20° F.

12. A method for supplying carbon dioxide to one or more applications in a semiconductor manufacturing process, comprising the steps of
a. directing a fluid feed, that includes a carbon dioxide component, from a first carbon dioxide purifying means to one or more applications, whereby one or more contaminants are combined with the fluid feed at said applications, thereby forming an effluent at each said application, wherein each said effluent includes at least a portion of the carbon dioxide component and at least a portion of said contaminants;
b. adding a second component to at least one member of the group consisting of the fluid feed prior to at least one said application and at least one said application, wherein said second component is selected from the group consisting of co-solvents, surfactants, and chelators;
c. changing at least one physical property of the fluid feed prior to at least one said application, said property selected from the group consisting of temperature and pressure;
d. partially purifying at least a portion of the carbon dioxide component of at least one said effluent by one or more third carbon dioxide purifying means including the steps of
i) reducing the pressure of the effluent by an amount sufficient to separate the effluent into a plurality of phases, including at least one carbon dioxide enriched phase and at least one phase enriched in components other than carbon dioxide;
ii) directing at least one carbon dioxide enriched phase to said first purifying means, whereby the carbon dioxide component of said carbon dioxide enriched phase is purified; and
iii) directing at least one phase enriched in components other than carbon dioxide to at least one waste stream; and
e. purifying at least one member of the group consisting of the carbon dioxide component of said effluent and said carbon dioxide enriched phase, at said first purifying means, thereby producing said fluid feed, by
i) removing at least a portion of components that have vapor pressures different from the vapor pressure of carbon dioxide by using one or more means of distilling; and
iii) directing the portion of components so removed to at least one waste stream; and
f. adding carbon dioxide from a carbon dioxide source by a method selected from the group consisting of
i) combining carbon dioxide from the source with the effluent, whereby carbon dioxide from the source is purified by said first purifying means;
ii) adding carbon dioxide from the source to said first purifying means while purifying said carbon dioxide component of said effluent in said first purifying means, whereby carbon dioxide from the source is purified by said first purifying means; and
iii) pre-purifying carbon dioxide including the steps of
(1) purifying carbon dioxide from the source in a second carbon dioxide purifying means, thereby creating a pre-purified feed, wherein said second means includes at least one method selected from the group consisting of distillation, adsorption, and catalytic oxidation; and
(2) adding said pre-purified feed to at least one member of the group consisting of the fluid feed, at least one said application, the effluent, and said first purifying means; and
g. directing a portion of said fluid feed back to said first purifying means, thereby bypassing said applications and said third purifying means, whereby the first purifying means is operated as a continuous process.

13. A system for supplying carbon dioxide to one or more semiconductor manufacturing applications, comprising
a. a first carbon dioxide purifying means, which purifies a carbon dioxide component of an effluent,
whereby at least a portion of components that have vapor pressures different from the vapor pressure of carbon dioxide are removed,
thereby forming at least one waste stream,
thereby forming a fluid feed that includes the carbon dioxide as a component of said fluid feed,
wherein said first purifying means including at least one member of the group consisting of a catalytic oxidizer, a distillation column, and an adsorption bed;
b. a supply conduit for directing said fluid feed from the first purifying means to one or more applications, whereby one or more contaminants are combined with the fluid, thereby forming an effluent at each said application, wherein each said effluent includes at least a portion of the carbon dioxide component and at least a portion of said contaminants; and
c. a return conduit for directing said effluent from at least one said application to said first purifying means;
d. a carbon dioxide source; and
e. means to purify and add additional carbon dioxide from said source, said means selected from the group consisting of
i) means to direct carbon dioxide from the source to at least one member of the group consisting of the first purifying means, an effluent, and the return conduit, whereby carbon dioxide from the source is purified by said first purifying means before being directed to said applications; and
ii) means to purify and add carbon dioxide from the source including
(1) means to direct carbon dioxide from said source to a second carbon dioxide purifying means;
(2) a second carbon dioxide purifying means, thereby producing a purified feed, wherein said second purifying means includes at least one member of the group consisting of a distillation column, an adsorption bed, and a catalytic oxidizer; and
(3) means to add a purified feed to at least one member of the group consisting of the supply conduit, at least one said application, the return conduit, and said first purifying means.

14. The system of claim 13, further including means to add a second component into at least one member group consisting of the supply conduit and at least one said application.

15. The system of claim 14, further including means selected from the group consisting of a heat exchanger and a pressure controller, wherein said means is at a location selected from the group consisting of the supply conduit and at least one said application.

16. The system of claim 15, wherein said first purifying means includes a plurality of distillation columns that remove said components to at least one said waste stream, wherein at least one said column removes at least a portion of components that have vapor pressures higher than carbon dioxide and at least one column removes at least a portion of components that have vapor pressures lower than carbon dioxide.

17. The system of claim 16 further including one or more third carbon dioxide purifying means that partially purifies at least a portion of the carbon dioxide component of the effluent by
a. reducing the pressure of the effluent by an amount sufficient to separate the effluent into a plurality of phases, including at least one carbon dioxide enriched phase and at least one phase enriched in components other than carbon dioxide;
b. directing at least one carbon dioxide enriched phase to said first purifying means, whereby the carbon dioxide component of said carbon dioxide enriched phase is purified; and
c. directing at least one phase enriched in components other than carbon dioxide to at least one waste stream.

18. The system of claim 17, further comprising at least one means selected from the group consisting of an adsorption bed and a filter, wherein said means are located at a member of the group consisting of the supply conduit and the first purifying means.

19. The system of claim 18, wherein said first purifying means includes at least one component selected from the group consisting of a catalytic oxidizer, an acid scrubber, and a base scrubber.

20. The system of claim 19, further comprising a bypass conduit whereby a portion of said fluid feed is directed back to said first purifying means, thereby bypassing said applications and said third purifying means, whereby the first purifying means is operated as a continuous process.

21. A system for supplying carbon dioxide to one or more semiconductor manufacturing applications, comprising
a. a first carbon dioxide purifying means, which purifies a carbon dioxide component of an effluent to form a fluid feed that includes carbon dioxide as a component of said fluid feed, and directs at least a portion of components that have vapor pressures different from that of carbon dioxide to at least one waste stream, including
i) at least one distillation column that removes at least a portion of components that have vapor pressures higher than that of carbon dioxide; and
ii) at least one distillation column that removes at least a portion of components that have vapor pressures lower than that of carbon dioxide; and
b. a supply conduit for directing said fluid feed from the first purifying means to one or more applications, whereby one or more contaminants are combined with the fluid, thereby forming an effluent at each said application, wherein each said effluent includes at least a portion of the carbon dioxide component and at least a portion of said contaminants;
c. means selected from the group consisting of a heat exchanger and a pressure controller, wherein said means is at a location selected from the group consisting of the supply conduit and at least one said application;
d. means to add a second component, wherein said means is at a location selected from the group consisting of the supply conduit and an application;
e. a return conduit for directing said effluent from at least one said application to at least one member of the group consisting of said first purifying means and a third purifying means;
f. at least one third purifying means that partially purifies at least a portion of the carbon dioxide component of the effluent by
i) reducing the pressure of the effluent by an amount sufficient to separate the effluent into a plurality of phases, including at least one carbon dioxide enriched phase and at least one phase enriched in components other than carbon dioxide;
ii) directing at least one carbon dioxide enriched phase to said first purifying means, whereby the carbon dioxide component of said carbon dioxide enriched phase is purified; and
iii) directing at least one phase enriched in components other than carbon dioxide to at least one waste stream; and
g. a bypass conduit to direct a portion of said fluid feed back to said first purifying means, thereby bypassing said applications and said third purifying means, whereby the first purifying means is operated as a continuous process;
h. a carbon dioxide source; and
i. means to purify and add additional carbon dioxide from said source, said means selected from the group consisting of
i) means to direct carbon dioxide from a carbon dioxide source to at least one member of the group consisting of the first purifying means, an effluent, and the return conduit, whereby carbon dioxide from the source is purified by said first purifying means before being directed to said applications; and
ii) means to add purified carbon dioxide from a carbon dioxide source including
(1) means to direct carbon dioxide from said source to a second carbon dioxide purifying means;
(2) a second carbon dioxide purifying means, thereby producing a purified feed, wherein said second purifying means includes at least one member of the group consisting of a distillation column, an adsorption bed, and a catalytic oxidizer; and
(3) means to add a purified feed to at least one member of the group consisting of the supply conduit, at least one said application, the return conduit, and said first purifying means.
